(19) United States
(12) Patent Application Publication
(10) Pub. No.: US 2002/0144120 A1
(43) Pub. Date: Oct. 3, 2002

(54) Method and apparatus for constructing digital certificates

(76) Inventor: Ramanathan Ramanathan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/820,110

(22) Filed: Mar. 28, 2001

(51) Int. Cl. H04L 9/00

(52) U.S. Cl. 713/175

(57) ABSTRACT

A method and apparatus for constructing digital certificates comprising writing a party's authenticating information and a digital certificate issuing authorities authenticating information in an electronic document; signing the electronic document to obtain a once signed electronic document; and transmitting the once signed electronic document to a second digital certificate issuing authority to obtain a twice signed electronic document.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

### FIELD OF THE INVENTION

The present invention is related to the field of electronic-commerce. In particular, the present invention is related to a method and apparatus for storing digital contracts and digital certificates for long periods of time.

### DESCRIPTION OF THE RELATED ART

Doing business online (e-business) is an accepted business method. However, the Internet as currently structured can be an insecure communications channel. To facilitate e-business, secure encryption methods are available for the transfer of personal information such as home addresses, social security numbers, and credit card information. Public key infrastructure (PKI) is well known in the art, and includes a combination of software, encryption technologies, and services that enable business entities and individuals to protect the privacy of their communications and business transactions on the Internet. PKIs integrate digital certificates, public-key cryptography, and certificate authorities into a network security architecture. A typical PKI architecture encompasses the issuances of digital certificates to individual users and servers, end-user enrollment software, integration with corporate certificate directories, and tools for managing, renewing, and revoking certificates.

Rivest-Shamir-Adleman (RSA) is an Internet encryption and authentication system that is commonly used to encrypt and authenticate individuals and entities, and is included in many Web browsers and software packages. This method uses both a private and a public key. Each recipient has a private key that is kept secret and a public key that is published. The sender uses the recipient's public key to encrypt a message. The recipient uses his own private key to decrypt the message. To send an encrypted signature the sender uses his private key to encrypt the signature, and the recipient uses the sender's public key to decrypt the signature and to authenticate the sender. Thus, the private keys are not transmitted and are thereby secure.

A digital certificate is an electronic certificate that establishes one's authenticity, for example, when doing business on the Internet. A digital certificate is issued by a digital certificate issuing authority. The information contained in the digital certificate includes the digital certificate holder's identifying information, such as the digital certificate owner's name, social security number, or bio-identity information. Examples of bio-identity information include digitized iris scans or digitized finger prints. A digital certificate may include a serial number, an expiration date of the certificate, the certificate holder's public key, and the identity of the encryption algorithm used by the owner of the digital certificate. A digital certificate also includes the identity of the encryption algorithm used by the digital certificate issuing authority when signing the digital certificate, and the digital signature of the digital certificate issuing authority so that a recipient may verify the authenticity of the digital certificate. When signing a digital certificate, the digital certificate issuing authority computes a hash value based on the information contained in the digital certificate and encrypts the hash value using the digital certificate issuing authority's private key. The encrypted hash value is then included in the digital certificate. This permits a verification of the identity of the owner of a digital certificate.

In order to verify the identity of the owner of the digital certificate, an interested party obtains the public key of the digital certificate issuing authority from, e.g., the issuing authority's web-site and uses the public key to decrypt the issuing authority's digital signature. By decrypting the digital signature of the digital certificate issuing authority, a hash value is obtained. Next, a hash value of the contents of the digital certificate is obtained based on the contents of the digital certificate input into the hash algorithm specified in the digital certificate. If the hash value obtained is equal to the hash value obtained earlier, the identity of the owner of the digital certificate is confirmed.

However, if the digital certificate issuing authority ceases to exist at some point in the future it may be virtually impossible to validate the digital certificate, and hence confirm the identity of the owner of the digital certificate. What is needed, therefore, is a method and apparatus to construct a digital certificate so that the digital certificate may be validated in the event the digital certificate issuing authority ceases to exist.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a diagram of a digital certificate.

FIG. 2 illustrates a flow diagram for constructing a digital certificate in accordance with one embodiment of the invention.

FIG. 3 illustrates a diagram of a digital certificate in accordance with one embodiment of the invention FIG. 4 illustrates a block diagram of an apparatus that generates a digital certificate in accordance with one embodiment of the invention.

### DETAILED DESCRIPTION OF THE INVENTION

Described is a method and apparatus for constructing digital certificates so that the digital certificates may be validated even if the digital certificate issuing authority ceases to exist. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention. For example, specific details are not provided as to whether the method is implemented in a router, server or gateway, as a software routine, hardware circuit, firmware, or a combination thereof.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

The invention may utilize a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the Internet.

The detailed description which follows is represented largely in terms of processes and symbolic representations of operations by conventional computer components, including a local processing unit, memory storage devices for the local processing unit, display devices, and input devices. Furthermore, these processes and operations may utilize conventional computer components in a heterogeneous distributed computing environment, including remote file servers, computer servers, and memory storage devices. Each of these conventional distributed computing components is accessible to the local processing unit by a communication network.

In addition, it should be understood that the programs, processes, method, etc., described herein are not related or limited to any particular computer or apparatus nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory such as read only memory.

Various operations will be described as multiple discrete steps performed in turn in a manner that is helpful in understanding the present invention. However, the order of description should not be construed as to imply that these operations are necessarily performed in the order they are presented, or even order dependent. Lastly, repeated usage of the phrase “in one embodiment” does not necessarily refer to the same embodiment, although it may.

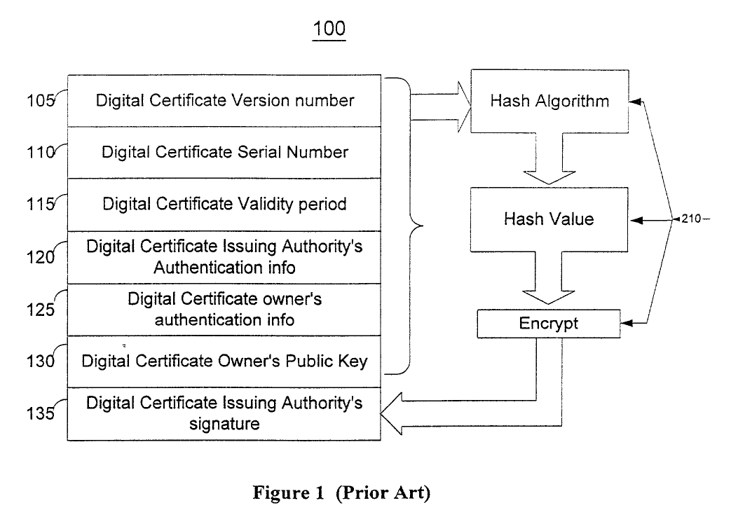

Turning now to the drawings. FIG. 1 illustrates a diagram of a digital certificate in accordance with a prior art embodiment. As illustrated in FIG. 1, a digital certificate 100 comprises a digital certificate version number 105, a digital certificate serial number 110, and a validity period 115. Included in the digital certificate is the digital certificate issuing authority's authentication information 120, e.g., the digital certificate issuing authority's name, address, and the identity of the hash algorithm used by the digital certificate issuing authority to sign the digital certificate. A digital certificate also includes the digital certificate owner's authentication information 125, i.e., the owner's name, address, social security number, bio identity information etc., and the identity of the hash algorithm used by the owner, e.g., when signing electronic documents. In addition, a digital certificate may include the digital certificate owner's public key 130, and the digital certificate issuing authority's signature 135.

As stated earlier, if the digital certificate issuing authority ceases to exist at some point in the future and it is necessary to validate the digital certificate, the validation of the digital certificate constructed in accordance with prior art embodiments may be virtually impossible. One reason is that the public key of the digital certificate issuing authority may be unavailable. However, if the digital certificate issuing authority has a grantor or root digital certificate issuing authority that grants the digital certificate issuing authority the right to issue digital certificates, it may be possible to validate the issued digital certificate despite the non existence of the digital certificate issuing authority. One method for validating the issued digital certificate is to include the digital signature of the root digital certificate issuing authority in the digital certificate during the formation of the digital certificate. The process of including the digital signature of the root digital certificate issuing authority in the digital certificate will now be described.

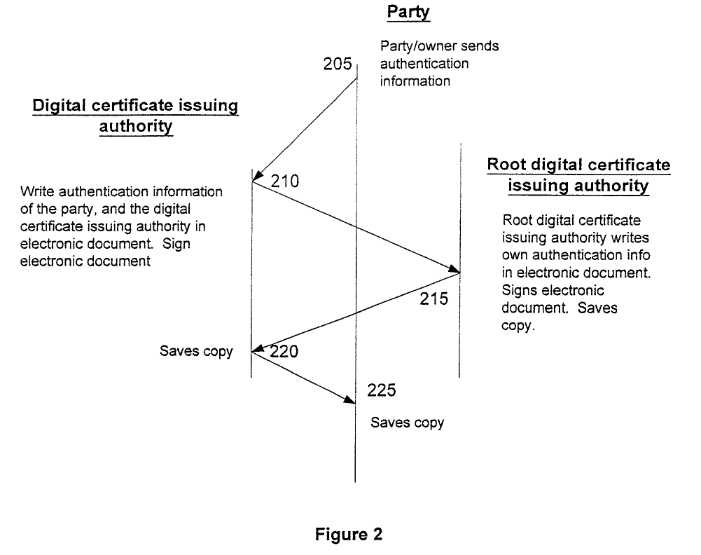

FIG. 2 illustrates a flow diagram for constructing a digital certificate in accordance with one embodiment of the invention. As FIG. 2 illustrates, at 205, a party or one requesting a digital certificate sends its authentication information such as its name, address, social security number, bio identity information, etc., to a digital certificate issuing authority. Transmissions of data during the formation of the digital certificate may be done via secure connections. Transmissions of data via secure connections are well known in the art and will not be described herein. At 210, the digital certificate issuing authority writes the party's authentication information in an electronic document, for example, a text file, along with its own authenticating information. In one embodiment, the authenticating information of the digital certificate issuing authority includes its name, its address, and the identity of hash algorithm used in its digital signature. The digital certificate issuing authority may also include other essential information such as the digital certificate version number, the digital certificate serial number, the validity period of the digital certificate, and the digital certificate owner's public key in the electronic document. The digital certificate issuing authority then signs the electronic document. Signing the electronic document includes the digital certificate issuing authority inserting the aforementioned information into the hash algorithm to obtain a hash value. The hash value is then encrypted using the digital certificate issuing authority's private key, and the encrypted hash value is included in the electronic document. The electronic document is then transmitted to the root digital certificate issuing authority.

In one embodiment, if there are other digital certificate issuing authorities in the hierarchy below the root authority, the electronic document is signed by each digital certificate issuing authority prior to transmitting the electronic document to the root digital certificate issuing authority. On receiving the electronic document with the digital signature of the digital certificate issuing authority, at 215, the root digital certificate issuing authority includes its authentication information, e.g., its name, address, and identity of the hash algorithm it uses to sign the digital certificate in the electronic document. The root digital certificate issuing authority then signs the electronic document to form a digital certificate, and transmits a copy of the digital certificate. In one embodiment the root digital certificate issuing authority may transmit the digital certificate to the party as well as to the digital certificate issuing authority. On receiving the digital certificate, at 220, the digital certificate issuing authority may save a copy of the digital certificate prior to transmitting the digital certificate to the requesting party.

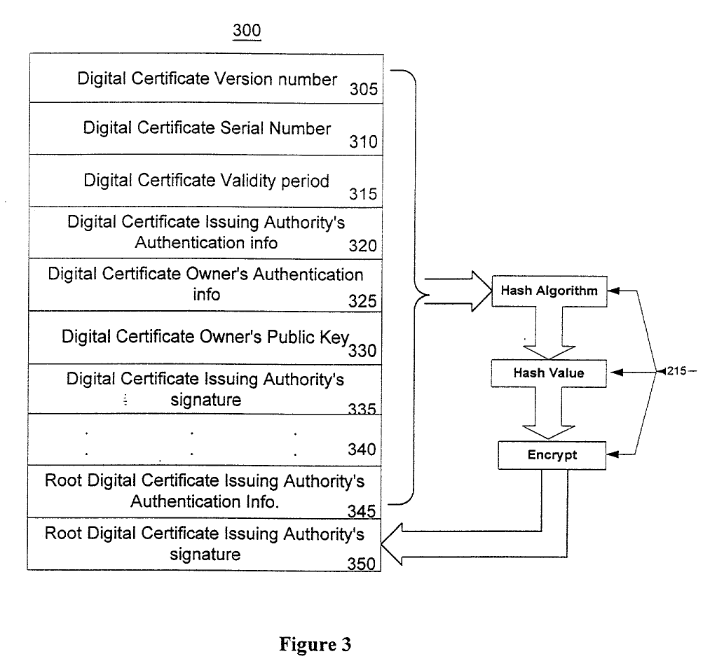

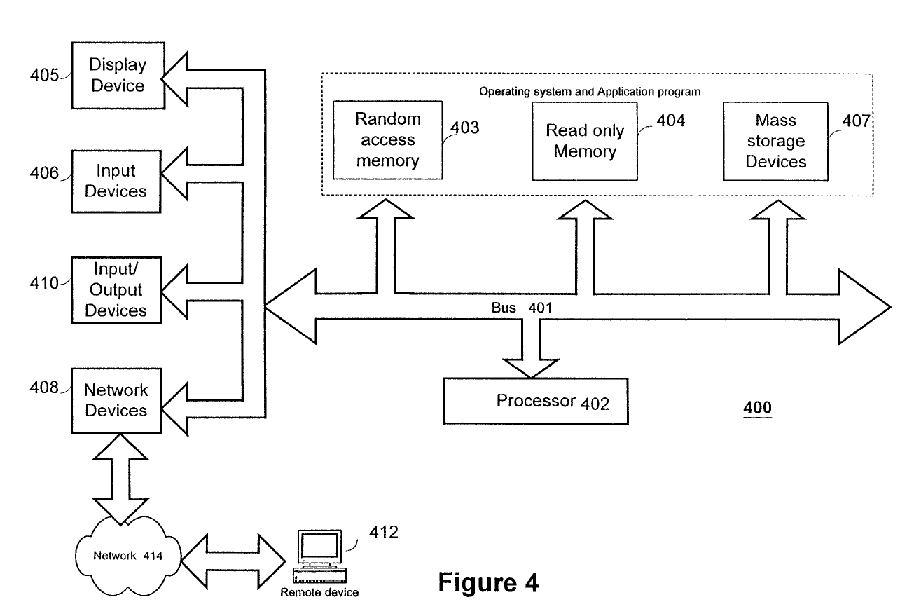

FIG. 3 illustrates a block diagram of a digital certificate, 300, in accordance with one embodiment of the invention. As FIG. 3 illustrates, at 305-315, the digital certificate includes the digital certificate version number, the digital certificate serial number and the validity period of the digital certificate, if any. At 320, the digital certificate contains the digital certificate issuing authority's authentication information, e.g., its name, its address, and the identity of the hash algorithm it uses in its digital signature. At 325-330, the digital certificate contains the digital certificate owner's authentication information, e.g., its name address, social security number, bio identity information, etc., and the identity of the hash algorithm it uses in its digital signature, and the digital certificate owner's public key. At 335, the digital certificate contains the digital certificate issuing authority's signature. At 340, if more than one digital certificate issuing authority exists in the chain of digital certificate issuing authorities, then each digital certificate issuing authority's authentication information and signature may be included in the digital certificate. At 345-350, the digital certificate includes the authentication information of the root digital certificate issuing authority, e.g., its name and address, the identity of the hash algorithm used in its digital signature, and the signature of the root digital certificate issuing authority.

In the digital certificate disclosed above, if the digital certificate issuing authority ceases to exist at some point in the future, the root digital authority's signature and authentication information that is available in the digital certificate and may be used to validate the digital certificate. For example, using the hash algorithm identified in the root digital certificate authentication information, the contents of the electronic document received by the root digital certificate issuing authority during the creation of the digital certificate may be input in the hash algorithm to obtain a hash value. Next, the root digital certificate issuing authority's public key is obtained, e.g., from the root digital certificate issuing authority's web site, and is used to decrypt the encrypted signature of the root digital certificate issuing authority that is included in the digital certificate. If the two hash values match then the digital certificate is validated.

FIG. 4 is a block diagram of a computer system that may be used to generate a digital certificate. In general, such computer systems as illustrated by FIG. 4 includes a processor 402 coupled through a bus 401 to a random access memory (RAM) 403, a read only memory (ROM) 404, and a mass storage device 407. Mass storage device 407 represents a persistent data storage device, such as a floppy disk drive, fixed disk drive (e.g., magnetic, optical, magneto-optical, or the like), or streaming tape drive. Processor 402 may be any of a wide variety of general purpose processors or microprocessors (such as the Pentium® processor manufactured by Intel® Corporation), a special purpose processor, or a specifically programmed logic device.

Display device 405 is coupled to processor 402 through bus 401 and provides graphical output for computer system 400. Input devices 406 such as a keyboard or mouse are coupled to bus 401 for communicating information and command selections to processor 402. Also coupled to processor 402 through bus 401 is an input/output interface 410 which can be used to control and transfer data to electronic devices (printers, other computers, etc.) connected to computer 400. Computer system 400 includes network devices 408 for connecting computer system 400 to a remote device 412, e.g., a root digital certificate issuing authority, via a network 414. Network devices 408, may include Ethernet devices, phone jacks and satellite links. It will be apparent to one of ordinary skill in the art that other network devices may also be utilized.

One embodiment of the invention may be stored entirely as a software product on mass storage 407. Another embodiment of the invention may be embedded in a hardware product 409, for example, in a printed circuit board, in a special purpose processor, or in a specifically programmed logic device communicatively coupled to bus 401. Still other embodiments of the invention may be implemented partially as a software product and partially as a hardware product.

Embodiments of the invention may be represented as a software product stored on a machine-accessible medium (also referred to as a computer-accessible medium or a processor-accessible medium). The machine-accessible medium may be any type of magnetic, optical, or electrical storage medium including a diskette, CD-ROM, memory device (volatile or non-volatile), or similar storage mechanism. The machine-accessible medium may contain various sets of instructions, code sequences, configuration information, or other data. Those of ordinary skill in the art will appreciate that other instructions and operations necessary to implement the described invention may also be stored on the machine-accessible medium.

Thus a method and apparatus have been disclosed for constructing digital certificates so that digital certificates may be validated even if the digital certificate issuing authority ceases to exist. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
writing a party's authenticating information and a first digital certificate issuing authority's authenticating information in an electronic document;
signing the electronic document to obtain a once signed electronic document; and
transmitting the once signed electronic document to a second digital certificate issuing authority to obtain a twice signed electronic document.

2. The method of claim 1 wherein signing the electronic document to obtain a once signed electronic document comprises:
obtaining a hash value using contents of the electronic document as input to a hash algorithm;
encrypting the hash value using the first digital certificate issuing authority's private key; and
storing the encrypted hash value in the electronic document.

3. The method of claim 1 wherein obtaining a twice signed electronic document comprises at least one of the second digital certificate issuing authority inserting its authenticating information in the once signed electronic document, obtaining a hash value using contents of the electronic document as input to a hash algorithm, encrypting the hash value using the second digital certificate issuing authority's private key, including the encrypted hash value in the electronic document, and transmitting the twice signed electronic document.

4. The method of claim 3 wherein obtaining a hash value using contents of the electronic document as input to a hash algorithm comprises at least one of, using the party's authenticating information, using the first digital certificate issuing authority's authenticating information, using the digital signature of the first digital certificate issuing authority, and using the second digital certificate issuing authority's authenticating information as input to a hash algorithm.

5. The method of claim 1, wherein writing a party's authenticating information and a first digital certificate issuing authority's authenticating information in an electronic document comprises receiving the party's authenticating information via a secure connection.

6. A computer system comprising:
a bus;
a data storage device coupled to said bus; and
a processor coupled to said data storage device, said processor operable to receive instructions which, when executed by the processor, cause the processor to perform a method comprising writing a party's authenticating information and a first digital certificate issuing authority's authenticating information in an electronic document;
`signing the electronic document to obtain a once signed electronic document; and
transmitting the once signed electronic document to a second digital certificate issuing authority to obtain a twice signed electronic document.

7. A computer system as in claim 6 wherein signing the electronic document to obtain a once signed electronic document comprises:
obtaining a hash value using contents of the electronic document as input to a hash algorithm;
encrypting the hash value using the first digital certificate issuing authority's private key; and
storing the encrypted hash value in the electronic document.

8. A computer system as in claim 6 wherein obtaining a twice signed electronic document comprises at least one of the second digital certificate issuing authority inserting its authenticating information in the once signed electronic document, obtaining a hash value using contents of the electronic document as input to a hash algorithm, encrypting the hash value using the second digital certificate issuing authority's private key, including the encrypted hash value in the electronic document, and transmitting the twice signed electronic document.

9. A computer system as in claim 8 wherein obtaining a hash value using contents of the electronic document as input to a hash algorithm comprises at least one of, using the party's authenticating information, using the first digital certificate issuing authority's authenticating information, using the digital signature of the first digital certificate issuing authority, and using the second digital certificate issuing authority's authenticating information as input to a hash algorithm.

10. A computer system as in claim 6 wherein writing a party's authenticating information and a first digital certificate issuing authorities authenticating information in an electronic document comprises receiving the party's authenticating information via a secure connection.

11. An article of manufacture comprising:
a machine-accessible medium including instructions that, when executed by a machine, causes the machine to perform operations comprising
writing a party's authenticating information and a first digital certificate issuing authorities authenticating information in an electronic document;
signing the electronic document to obtain a once signed electronic document; and
transmitting the once signed electronic document to a second digital certificate issuing authority to obtain a twice signed electronic document.

12. An article of manufacture as in claim 11 wherein signing the electronic document to obtain a once signed electronic document comprises:
obtaining a hash value using contents of the electronic document as input to a hash algorithm;
encrypting the hash value using the first digital certificate issuing authority's private key; and
storing the encrypted hash value in the electronic document.

13. An article of manufacture as in claim 11 wherein obtaining a twice signed electronic document comprises at least one of the second digital certificate issuing authority inserting its authenticating information in the once signed electronic document, obtaining a hash value using contents of the electronic document as input to a hash algorithm, encrypting the hash value using the second digital certificate issuing authority's private key, including the encrypted hash value in the electronic document, and transmitting the twice signed electronic document.

14. An article of manufacture as in claim 13 wherein obtaining a hash value using contents of the electronic document as input to a hash algorithm comprises at least one of, using the party's authenticating information, using the first digital certificate issuing authorities authenticating information, using the digital signature of the first digital certificate issuing authority, and using the second digital certificate issuing authority's authenticating information as input to a hash algorithm.

15. An article of manufacture as in claim 11 wherein writing a party's authenticating information and a first digital certificate issuing authorities authenticating information in an electronic document comprises receiving the party's authenticating information via a secure connection.

16. A method comprising:
receiving a once signed electronic document;
writing a digital certificate issuing authority's authenticating information in the once signed electronic document;
signing the once signed electronic document to form a twice signed electronic document; and
transmitting the twice signed electronic document.

17. The method of claim 16 wherein signing the once signed electronic document to form a twice signed electronic document comprises:
obtaining a hash value using contents of the once signed electronic document and using the digital certificate issuing authority's authenticating information as input to a hash algorithm;
encrypting the hash value using the digital certificate issuing authority's private key; and
writing the encrypted hash value in the electronic document.

18. A computer system comprising:
a bus;
a data storage device coupled to said bus; and
a processor coupled to said data storage device, said processor operable to receive instructions which, when executed by the processor, cause the processor to perform a method comprising receiving a once signed electronic document;
writing a digital certificate issuing authority's authenticating information in the once signed electronic document;
signing the once signed electronic document to form a twice signed electronic document; and
transmitting the twice signed electronic document.

19. A computer system as in claim 18 wherein signing the once signed electronic document to form a twice signed electronic document comprises:
obtaining a hash value using contents of the once signed electronic document and using the digital certificate issuing authority's authenticating information as input to a hash algorithm;
encrypting the hash value using the digital certificate issuing authority's private key; and
writing the encrypted hash value in the electronic document.

20. An article of manufacture comprising:
a machine-accessible medium including instructions that, when executed by a machine, causes the machine to perform operations comprising receiving a once signed electronic document;
writing a digital certificate issuing authority's authenticating information in the once signed electronic document;
signing the once signed electronic document to form a twice signed electronic document; and
transmitting the twice signed electronic document.

21. An article of manufacture as in claim 20 wherein signing the once signed electronic document to form a twice signed electronic document comprises:
obtaining a hash value using contents of the once signed electronic document and using the digital certificate issuing authority's authenticating information as input to a hash algorithm;
encrypting the hash value using the digital certificate issuing authority's private key; and
writing the encrypted hash value in the electronic document.
